(19) United States
(12) Patent Application Publication
(10) Pub. No.: US 2001/0050049 A1
(43) Pub. Date: Dec. 13, 2001

(54) Central powder supply plant

(76) Inventors: Erich Kramer, Michelau (DE); Matthias Kramer, Michelau (DE)

Correspondence Address: HENRY M FEIEREISEN, 350 FIFTH AVENUE, SUITE 3220, NEW YORK, NY, 10118

(21) Appl. No.: 09/911,606

(22) Filed: Jul. 24, 2001

Related U.S. Application Data
(63) Continuation of application No. PCT/EP00/00596, filed on Jan. 26, 2000.

(30) Foreign Application Priority Data
Jan. 29, 1999 (DE) 199 03 578.4

(51) Int. Cl. B05B 5/025

(52) U.S. Cl. 118/638

(57) ABSTRACT

A central powder supply plant, includes a housing; and operating and control devices, integrated in the housing, for powder supply and/or electrostatic. The operating and control devices can be arranged individually or in groups or they may be combined to units.

### CROSS-REFERENCES TO RELATED APPLICATIONS

This application is a continuation of prior filed copending PCT International application no. PCT/EP00/00596, filed Jan. 26, 2000.

This application claims the priority of German Patent Application Ser. No. 199 03 578.4, filed Jan. 29, 1999, the subject matter of which is incorporated herein by reference.

### BACKGROUND OF THE INVENTION

The present invention relates to a central powder supply plant with operating and control devices for the powder supply and/or the electrostatic

With central powder supply plants, in particular with high-performance powder coating plants that include several powder coating devices to which powder has to be supplied, it is often difficult and space-demanding to maintain a constant quality during the coating process, when the operating and control devices required for operating the powder coating plant and the central powder supply plant are housed, for example, in separate cabinets which, in some cases, are located remote from the powder coating devices and the central powder supply plant. Moreover, such separate cabinets for the operating and control devices require considerable additional space and, more particularly, relatively long connections are provided between the operating and control devices and the devices to be controlled. This can cause a malfunction and adversely affect the qualitative reproducibility of the coating results.

One example of a central powder supply plant is described in the commonly assigned earlier German patent application 198 23 068.0, which is included in its entirety by a reference in the present application.

It is a therefore be desirable and advantageous to provide an improved central powder supply plant to obviate prior art shortcomings and to be so configured as to take up a minimum amount of space and to require only short connections between operating and control devices and the devices to be controlled.

### SUMMARY OF THE INVENTION

According to one aspect of the present invention, a central powder supply plant is provided having incorporated therein operating and control devices for the powder supply and/or the electrostatic control. In this way, the operating and control devices can be housed so as to take up minimum space, and can be located close to the respective devices to be controlled. The compact design of the central powder supply plant improves the operating comfort and simplifies maintenance and adjustment tasks. Moreover, a central powder supply plant designed in this manner is also easily accessible. The short connections between the operating and control devices and the devices to be controlled reduce the risk of malfunctions, in particular malfunctions that can affect the coating formation and reduce the quality of the applied coatings.

Suitably, the operating and control devices for the powder supply and/or the electrostatic can be arranged individually or in groups inside or on the central powder supply plant. If the devices are arranged in groups, functional associations can be taken into account, so that operating and control devices that have the same function or forming a functional unit can be assembled. Depending on the application, the operating and control devices can hereby be integrated more flexibly and almost universally.

According to a suitable embodiment, the operating and control devices for the powder supply and/or electrostatic are combined into units which are preferably of modular design. The modular design of the operating and control devices for the powder supply and/or electrostatic allows corresponding units to be assembled so as to be easily accessible and to be replaceable as a unit, if necessary. If required, additional operating and control devices can be easily added.

Suitably, the units can be designed as plug-in devices. Such a design is particularly suitable for central powder supply plants which have several subdivided chambers with double bottoms and/or double walls.

Depending on the application and the requirements, the operating and control devices, which are arranged individually or in groups and are combined into units and optionally integrated in combination with the central powder supply plant of the invention, can be arranged horizontally, vertically, laterally, or as a combination thereof. Accordingly, with the arrangement of the invention, the operating and control devices can be arranged on the central powder supply plant so as to be located as closely as possible to the devices to be controlled. This results in the shortest possible connecting lines and in a compact integration in the central powder supply plant. Thanks to its compact construction, the central powder supply plant is easily accessible and can be serviced quickly and cleaned reliably when changing paint.

To keep the complexity of assembly to a minimum as well as to prevent mistakes during assembly and, more particularly, to prevent failure of hose connections, the devices in the central powder supply plant of the invention that transport air and/or powder are connected in a tubeless manner. In this way, the operating and control devices for the powder supply and/or electrostatic can be located proximate to the devices to be controlled which improves coating quality and results in more uniform coatings. The use of tubeless connections lowers the cleaning cost and the time required for cleaning. In particular, the connections require almost no maintenance and are largely unaffected by external conditions.

Suitably, the tubeless connections are formed by formfitting and/or force-transmitting connecting devices. In particular, connecting devices in the form of conical seat connections with seals are preferred. Such tubeless connections are self-centering and can be released quickly and easily if required.

A tubeless connection is used, in particular in central powder supply plants, for the injectors on the air supply side and/or the powder intake side. Injectors are used in central powder supply plants for drawing in and/or transporting the powder and represent a central connecting element for the powder supply. The injectors are supplied with supply air and proportioning air. The injectors should also have a connection for drawing in fluidized powder and a discharge connection for connection with the powder coating device. These connections have to be sealed to operate reliably. The tubeless connections of the invention eliminate a large number of complex assembly steps. Moreover, an injector with all the required supply connections can be designed in compact form, and several injectors can be arranged in a space-saving arrangement so as to be easily accessible in the central powder supply plant of the invention.

For establishing the tubeless connections, holding-down devices can be used to apply a pressing force to the injectors individually or in groups. With this arrangement, defective injectors can be quickly exchanged, in particular, the holding-down devices can apply the required uniform pressure so that the tubeless connections are reliably sealed at the connection points. In a particular design, a common force is applied to the holding-down device which biases the injectors reliably and uniformly. With this design, only those elements of complementary design that are to be connected to communicate with one another, have to be placed on top of one another. By applying the pressing force with the holding-down device, the desired sealed connection between the elements is established due to the self-centering characteristic of the tubeless connection.

Assembly can be further simplified by connecting the holding-down device with collective supply lines that supply the injectors with supply and/or proportioning air. The holding-down device can simultaneously take on, for example, a distribution function for the individual injectors in the corresponding connections. Using collective supply lines saves space and simplifies assembly of the central powder supply plant of the invention.

The injectors are suitably arranged in groups and releaseably connected to a common support. With this arrangement, the injectors can be exchanged individually even during operation of the powder coating plant; alternatively, several injectors can be handled as a group together with the support. This can be advantageous during cleaning, for example when changing paint.

When a change of paint requires a complete cleaning of the powder coating plant, the required cleaning tasks are, on the one hand, simplified considerably because the tubeless connections have no hidden corners where powder can accumulate, and on the other hand, the connections can also be quickly released, for example, from the injectors and the connectors. More particularly, the injectors together with the support can be cleaned simultaneously and independent of other cleaning tasks by releasing the connecting devices on the powder intake side and operatively connecting the support and the injectors to an integrated or separate cleaning device. Such cleaning device can be located, for example, underneath the bottom that receives a powder supply container, either integrated therewith or separate therefrom. A single cleaning device can thereby clean several injectors simultaneously. This arrangement simplifies and reduces the time required for the cleaning operations, which may be important for high-performance powder coating plants which in order to be efficient, should have a very short downtime during a change of paint.

Optionally, the injectors can also be cleaned in a counterflow configuration, i.e., they can be cleaned with a cleaning device in two opposing flow directions. The injectors can be oriented on the common support in a first position and an opposing position, enabling counterflow cleaning of the injectors.

Optionally, the cleaning operations in such central powder supply plant or in a powder coating plant can be performed at a high pressure, using, for example, high-pressure compressed air.

According to another feature of the present invention, a central powder supply plant may have an intake device formed as a plate which is surrounded by a screen basket. The central powder supply plant of the invention uses air for cleaning which transports ball-shaped cleaning elements or the like through the openings of the plate-shaped intake device, wherein the ball-shaped cleaning elements are trapped by and collected in the screen basket after passing through the openings. With this design, the screen basket which surrounds the intake plate and aids in preventing the formation of lumps during fluidization of the powder, functions also as a collection container when cleaning implements are used, such as the ball-shaped cleaning elements or the like. After the cleaning operation is complete, the screen baskets can be taken off, and the accumulated ball-shaped cleaning elements can be removed quickly and easily from the plant. This preferred cleaning method for a central powder supply plant can also use cleaning implements, such as ball-shaped cleaning elements and the like.

In summary, a central powder supply plant according to the present invention has, on one hand, an integrated, space-saving, functional housing for the operating and control devices for the powder supply and/or the electrostatic, and, on the other hand, significantly simplifies the installation, in particular, with respect to the connecting lines and the like. Cleaning operations may be performed quickly and effectively by using an intake device in the form of a plate, in particular in conjunction with cleaning implements, such as ball-shaped cleaning elements and the like.

### BRIEF DESCRIPTION OF THE DRAWING

Other features and advantages of the present invention will be more readily apparent upon reading the following description of preferred exemplified embodiments of the invention with reference to the accompanying drawing, in which:

FIG. 1 is a schematic partial cross-sectional view of-one embodiment of a central powder supply plant according to the present invention;

FIG. 2 is an enlarged detailed view of the area encircled in FIG. 1 by reference character X to show an example of a tubeless connection of a control connection for an injector;

FIG. 3 is a schematic cross-sectional view of several tubeless connections of an injector;

FIG. 4 is a schematic side view of another example of tubeless connections in conjunction with a holding-down device for injectors;

FIG. 5 is a schematic view of an embodiment having collective connecting lines for the supply of the injectors with supply and/or proportioning air; and

FIG. 6 is a fragmentary schematic, perspective illustration of another embodiment of a central powder supply plant according to the present invention to show a cleaning operation using air and cleaning implements, such as ball-shaped cleaning elements and the like.

### DETAILED DESCRIPTION OF PREFERRED EMBODIMENTS

It will be understood that the preferred embodiments described with reference to the drawings are meant to be merely exemplary and in no way as limiting the scope of the invention.

Throughout all the Figures, same or corresponding elements are generally indicated by same reference numerals.

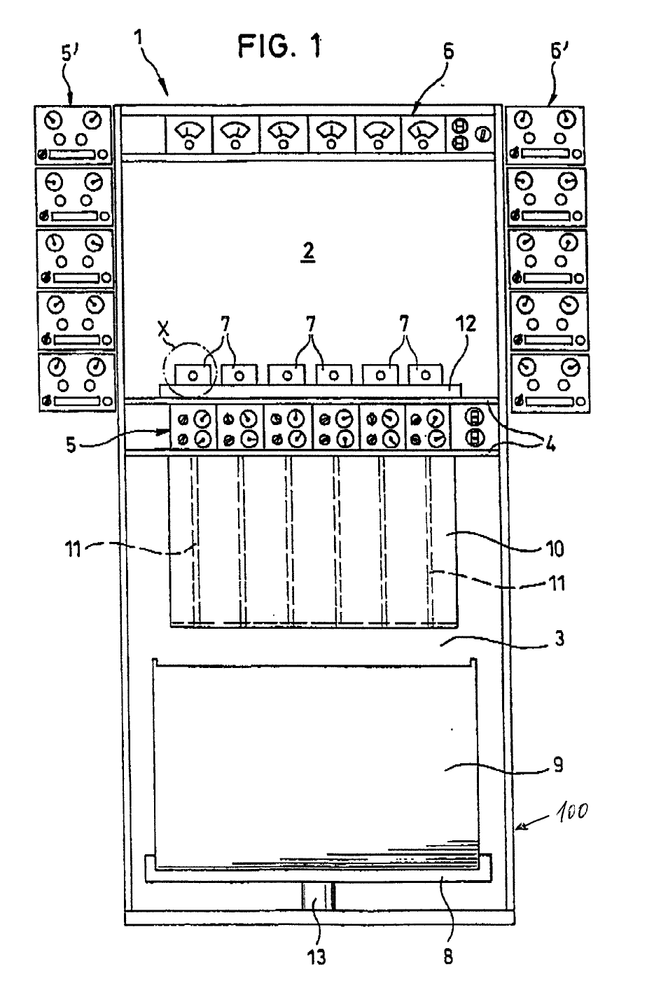

Turning now to the drawing, and in particular to FIG. 1, there is shown an example of a central powder supply plant according to the present invention, generally designated by reference numeral 1 and having a configuration which is based in part on a design described in German Offenlegungsschrift 198 23 068.0, the entire specification and drawings of which are expressly incorporated herein by reference. In the non-limiting example of FIG. 1, the central powder supply plant 1 has a housing 100 which includes an upper chamber 2 and a lower chamber 3, which are separated by double bottoms 4. Of course, the walls of the central powder supply plant 1 may also be configured as double walls, and optionally additional partitioning floors and/or partitioning walls may be provided as well.

In the illustrated example, operating and control devices for the powder supply are provided and designated in its entirety with reference numeral 5. Also provided are operating and control devices for electrostatic control, generally designated by reference numeral 6. The operating and control devices 5 for the powder supply include on and off switches, shown schematically, and, schematically shown, control devices, for example, for the supply and proportioning air for the injectors 7. The operating and control devices 5 for the powder supply and the operating and control devices 6 for electrostatic control are integrated in the housing 100 of the central powder supply plant 1.

In the non-limiting example of FIG. 1, the operating and control devices 5 for the powder supply are combined into a single unit, and the operating and control devices 6 for the electrostatic are also combined into a single unit. Both units are designed as plug-in devices which are oriented horizontally the central powder supply plant 1. The operating and control devices 5 for the powder supply are arranged in close proximity to the injectors 7 and preferably inside the injectors in form of a plug-in module.

Of course, the operating and control devices 5 for the powder supply and/or the operating and control devices 6 for the electrostatic can also be arranged individually or integrated into groups in the central powder supply plant 1. The operating and control devices 5 for the powder supply and/or the operating and control devices 6 for the electrostatic can be arranged—independent of their design—either horizontally, vertically or laterally or in a combination thereof in the central powder supply plant 1, as indicated schematically for a lateral arrangement by the reference numerals 5′ and 6′.

The central powder supply plant 1 further includes a table 8 for placement of a powder storage container 9. The illustrated exemplary powder supply device of the central powder supply plant 1 includes a plate-shaped intake device 10 with several openings 11 for fluidized powder. A group of injectors 7 is arranged on a rail-shaped support 12 and optionally releaseably connected to the support 12. The rail-shaped support 12 allows the injectors 7 to be handled uniformly and together. This is suitable, for example, when the injectors 7 during change of paint should be cleaned separately from the plate-shaped intake device 10. The rail-shaped support 12 can here be used to transport several injectors 7 that have been removed from the intake device 10, to a corresponding cleaning device (not shown). The cleaning device can be integrated in the central powder supply plant 1 or arranged separately therefrom. For example, such a cleaning device can be installed within the bottom of the table 8 or located underneath the table. For this purpose, the bottom of the table 8 can have a cutout with corresponding dimensions. A suitable cleaning device can also be releaseably connected to the table 8 of the central powder supply plant 1. A lifting device 13 can be used to move the table 8 with the powder storage container 9 placed thereon towards or away from the plate-shaped intake device 10.

Fluidized powder is drawn in by the injectors 7 via the openings 11 of the plate-shaped intake device 10 and transported to powder application devices, such as powder guns (not shown).

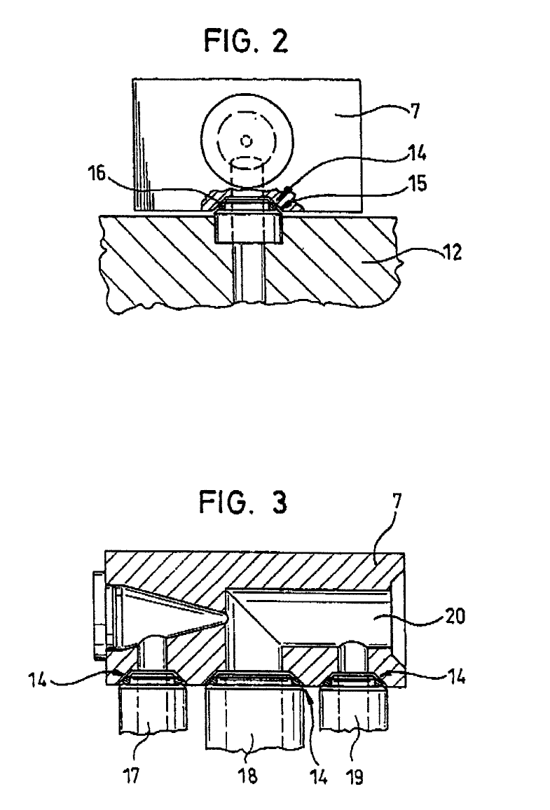

FIGS. 2 and 3 illustrate details of a preferred connection of the injectors 7 to associated devices of the central powder supply plant 1. FIG. 2 shows an exemplary tubeless connection 14 for supplying control air to an injector 7. This tubeless connection 14 can be implemented as a formfitting and/or force transmitting design. The associated connecting devices are formed by a conical seat connection 15 and a seal 16. FIG. 3 shows an embodiment of an injector 7 with a supply air connection 17, a powder connection 18 on the intake side, and a proportioning air connection 19. All these connections are located on the same side, for example the bottom side of the injector. The powder connection 18 on the intake side can be connected, for example, to the openings 11 in the plate-shaped intake device 10 depicted in FIG. 1. The powder which enters the injectors 7 via the powder connection 18 on the intake side, is transported together with the supply air via the supply air connection 17, and optionally together with proportioning air via a proportioning air connection 19, to a powder discharge connection 20. The connecting lines to the powder application devices (not shown) are connected to the powder discharge connection 20.

As shown schematically in FIG. 3, the connections are implemented on the air supply side, i.e., the side for the proportioning air 19 and the supply air 17, and on the side of the powder intake (intake side powder connection 18) as tubeless connections which include connecting devices that cooperate in a formfitting and/or force transmitting manner. The formfitting and/or force-transmitting connecting devices can also be formed as positive or negative complementary elements.

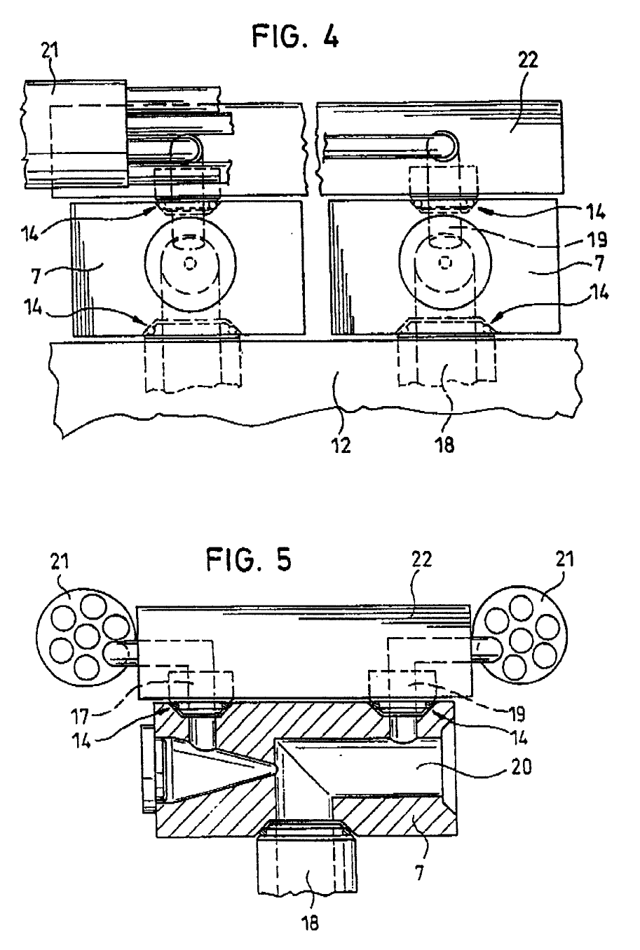

FIGS. 4 and 5 show additional embodiments, wherein, for example, the supply air connection 17 and the proportioning air connection 17 are located on one side of the injector 7, with the powder connection 18 on the intake side being located on the opposite side. The respective connections to the devices that are to be connected are also implemented in as tubeless connections. The powder discharge connection in the embodiments of FIGS. 4 and 5 also has the reference numeral 20. In the embodiment of the injectors of FIGS. 4 and 5, collective lines can be provided, for example, for the supply air and/or the proportioning air which are then connected to the respective connections of the injectors 7.

FIG. 4 shows more clearly a holding-down device 22 which can be used to apply a force to the injectors 7 which are arranged individually or in groups. The holding-down device 22, possibly in conjunction with the collective connecting lines 21, press the tubeless connections and the cooperating elements against each other. The tubeless connections provided in the central powder supply plant 1 are hereby easily and tightly sealed. Moreover, the tubeless connections can also be quickly released or separated by removing the pressing force from the holding-down device 22. This arrangement facilitates assembly and makes assembly and maintenance less expensive.

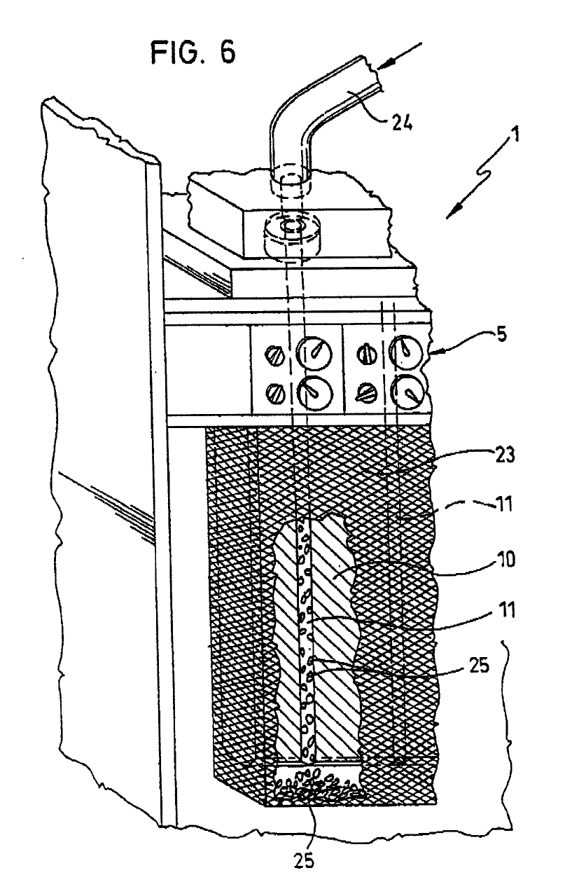

FIG. 6 depicts schematically an alternative embodiment of a central powder supply plant 1. In this embodiment, the afore-described injectors 7 can be removed and separately cleaned which may be necessitated by a change of paint in such a plant. The central powder supply plant 1 according to FIG. 6 has a plate-shaped intake device 10 similar to that illustrated in FIG. 1, which is surrounded by a screen basket 23. The plate-shaped intake device 10 has through-openings 11 powder extending through the plate. The exemplary plate-shaped intake device 10, illustrated in FIGS. 6, can be cleaned by connecting with an air supply line 24 to the openings 11. This can also be implemented by a tubeless connection, which is also illustrated in FIG. 6. In addition, cleaning implements, such as ball-shaped cleaning elements 25 and the like, are used which are transported by the air supply via the air supply line 24 through the openings 11 and the corresponding additional connecting devices. After passing through the openings 11, the ball-shaped cleaning elements 25 are captured in the screen basket 23 which surrounds the plate-shaped intake device 10. After the cleaning tasks are completed, the screen basket 23 can be taken off and the collected cleaning implements, such as the ball-shaped cleaning elements 25, can be removed from the plant together with a screen basket 23 and optionally recycled.

In the embodiment depicted in FIG. 6, the screen basket 23 operates therefore at the same time also as a catch container for the cleaning implements. A screen basket 23 of this type is provided, for example, in the German patent application 198 23 068.0 to prevent the formation of lumps during powder processing. However, in the embodiment of FIGS. 6, the screen basket 23 has an additional function aside from the known function.

While the invention has been illustrated and described as embodied in a central powder supply plant, it is not intended to be limited to the details shown since various modifications and structural changes may be made without departing in any way from the spirit of the present invention.

What is claimed as new and desired to be protected by Letters Patent is set forth in the appended claims:

What is claimed is:

1. A central powder supply plant, comprising a housing; and operating and control devices, integrated in the housing, for at least one of powder supply and electrostatic.

2. The central powder supply plant of claim 1, wherein the operating and control devices are arranged in the housing individually or in groups.

3. The central powder supply plant of claim 1, wherein the operating and control devices are combined into units.

4. The central powder supply plant of claim 3, wherein the operating and control devices have a modular construction.

5. The central powder supply plant of claim 3, wherein the units are designed as plug-in devices.

6. The central powder supply plant of claim 3, wherein the units are arranged in one of on the housing and in the housing in a manner selected from the group consisting of horizontally, vertically and laterally.

7. The central powder supply plant of claim 1, wherein the operating and control devices have elements which are interconnected in the housing by a tubeless connections, for transport of at least one of air and powder.

8. The central powder supply plant of claim 7, wherein the tubeless connections are formed by connecting devices that interact in at least one of a formfitting engagement and force-transmitting engagement.

9. The central powder supply plant of claim 8, wherein each of the connecting devices includes a conical seat connection with seal.

10. The central powder supply plant of claim 7, and further comprising injectors for ejecting powder, each of the injectors interacting with a corresponding one of the operating and control devices, whereby the injectors and the operating and control devices are placed into one-to-one correspondence, wherein each of the injectors is connected by a one of said tubeless connections on at least one of air side and powder intake side.

11. The central powder supply plant of claim 10, and further comprising a holding-down device which presses the injectors individually or in groups for establishing the tubeless connections.

12. The central powder supply plant of claim 11, and further comprising collective lines for supplying the injectors with supply air and/or proportioning air, wherein the holding-down device is configured for connection to the collective lines.

13. The central powder supply plant of claim 10, and further comprising a support, wherein the injectors are arranged in groups and releaseably connected to the support.

14. The central powder supply plant of claim 13, wherein the support and the injectors are configured for engagement with an integrated or separate cleaning device by releasing the connecting devices on the air-side and the powder intake side.

15. The central powder supply plant of claim 10, wherein the injectors are configured for cleaning action in opposite directions.

16. The central powder supply plant of claim 15, wherein the cleaning device is a high-pressure cleaning device.

17. A central powder supply plant, comprising an intake device in the form of a plate, a screen basket surrounding the intake device; and cleaning means transported through openings of the intake device, and collected in the screen basket (23).

18. The central powder supply plant of claim 17, wherein the cleaning means includes a ball-shaped cleaning element.

19. The central powder supply plant of claim 17, wherein the cleaning means is transported by air.
